(19) United States
(12) Patent Application Publication
(10) Pub. No.: US 2025/0297631 A1
(43) Pub. Date: Sep. 25, 2025

(54) METHOD AND SYSTEM WITH VOLATILITY-BASED FLOW DRILL SCREW CONTROL

(71) Applicant: Ford Global Technologies, LLC, Dearborn, MI (US)

(72) Inventors: Garret Sankey Huff, Ann Arbor, MI (US); Amanda Kay Freis, Ann Arbor, MI (US)

(73) Assignee: Ford Global Technologies, LLC, Dearborn, MI (US)

(21) Appl. No.: 18/610,907

(22) Filed: Mar. 20, 2024

(51) Int. Cl. F16B 25/10; B21J 5/06

(52) U.S. Cl. CPC F16B 25/106; B21J 5/066

(57) ABSTRACT

A method of installing a flow drill screw (FDS) into a substrate includes engaging the FDS with an automatic tool and operating the tool at a first setting to drive the FDS into the substrate. The first setting rotates the FDS at a first rotational speed and applies a first axial feed force. The first setting causes flow of the substrate to permit the FDS to penetrate the substrate. The method includes detecting, via a sensor, axial position data of the FDS while operating the automatic tool and calculating, via a controller, volatility of the axial position data. The method includes switching the automatic tool from the first setting to a second setting in response to the volatility. The second setting rotates the FDS at a second rotational speed and applies a second axial feed force to the FDS. The second rotational speed is less than the first rotational speed.

### FIELD

The present disclosure relates to a method and system for installing a flow drill screw.

### BACKGROUND

The statements in this section merely provide background information related to the present disclosure and may not constitute prior art.

A flow drill screw (FDS) is a specific type of screw that is used to generate a screw joint between a plurality of substrates, one of which being a lower substrate, without the use of part preparation like tapping a thread or punching a hole in the lower substrate. The lower substrate is typically metal and the total number of substrates is typically two to four, though other numbers can be used. The upper substrate(s) may or may not have a preformed thru-hole.

A typical FDS has a distal end portion that lacks threads or cutting edges and is configured to penetrate the substrate by locally heating the substrate with heat generated by rotational friction and axial pressure on the FDS. As the FDS penetrates the substrate, it forms threads in the substrate.

In a typical FDS process, an automatic tool is controlled to rotate the FDS at a high revolutions per minute (RPM) while applying an axial force toward the substrate. The typical FDS automatic tool does not directly control axial position. This high RPM, force generates the friction that heats the substrate and is maintained until the automatic tool detects a trigger condition, from real-time measured data, that corresponds to the beginning of penetration. Immediately upon detecting this trigger condition, the controller of the automatic tool signals the automatic tool to reduce the RPM and force. Thus, the automatic tool reduces the RPM and force before the thread forming portion of the FDS enters the substrate so that the thread forming and tightening of the FDS against the substrate can occur at a lower RPM and force. It is generally understood in the art that the RPM and force should be reduced as soon as penetration is achieved, but not before. It is generally accepted in the art that if the FDS has not fully penetrated prior to the step down in RPM and force, then there is a high chance that the FDS will ultimately not penetrate the lower substrate at all. This is due to the lower speed and/or force not generating sufficient heat or force to continue penetration and deformation of the metal. Additionally, it is generally believed by those in the art that it is important that the RPM and force are reduced before the thread forming portion enters the bottom substrate so that both there is sufficient process control as process completion nears (e.g., drive down and final tightening) and to allow the substrate to cool slightly before the thread forming portion enters the substrate and bushing region. It is also generally understood to be critical that the RPM and force are sufficiently low at the typical step down point of the process to have acceptable capability to stop the process upon reaching a target torque value, and not overshoot and strip the joint.

It is important that the torque applied to the FDS during the penetration portion of the installation process not rise above the rated torque value of the FDS.

The trigger condition is typically an axial position (i.e., depth) or an axial velocity (i.e., depth gradient) threshold value.

The teachings of the present disclosure address these and other issues with installing a FDS into a substrate.

### SUMMARY

This section provides a general summary of the disclosure and is not a comprehensive disclosure of its full scope or all of its features.

In one form, the present disclosure provides a method of installing a flow drill screw (FDS) into a substrate includes engaging the FDS with an automatic tool. The method includes operating the automatic tool at a first setting to drive the FDS into the substrate by causing flow of the substrate to permit the FDS to penetrate the substrate. The first setting is configured to rotate the FDS at a first rotational speed and to apply a first axial feed force on the FDS. The first setting is configured to cause flow of the substrate to permit the FDS to penetrate the substrate. The method includes detecting, via a sensor, axial position data of the FDS while operating the automatic tool. The method includes calculating, via a controller, volatility of the axial position data of the FDS. The method includes switching the automatic tool from the first setting to a second setting in response to the volatility. The second setting is configured to rotate the FDS at a second rotational speed and to apply a second axial feed force to the FDS. The second rotational speed is less than the first rotational speed.

In variations of the method of the above paragraph, which may be implemented individually or in any combination thereof: the controller switches the automatic tool from the first setting to the second setting in response to the controller determining a trigger condition has occurred, the trigger condition including at least one of a value of the volatility exceeding a predetermined volatility value and the value of the volatility being within a predetermined range of a maximum volatility value; the predetermined volatility value is greater than or equal to 0.5 mm; the controller is configured to wait a predetermined delay time after the controller determines that the trigger condition has occurred and before switching the automatic tool from the first setting to the second setting; the value is an average of the volatility over a subset of time; the controller switches the automatic tool from the first setting to the second setting in response to a maximum volatility value being achieved; the method further includes calculating a predicted maximum volatility value, wherein the controller switches the automatic tool from the first setting to the second setting based on the maximum volatility value predicted; the controller switches the automatic tool from the first setting to the second setting based on the maximum volatility value predicted but before the maximum volatility value is achieved; controller calculates the volatility using at least one of a true range (TR) formula and a standard deviation formula.

In another form, the present disclosure provides a method of installing a flow drill screw (FDS) into a substrate including engaging the FDS with an automatic tool. The method includes operating the automatic tool at a first setting to drive the FDS into the substrate by causing flow of the substrate to permit the FDS to penetrate the substrate. The first setting is configured to rotate the FDS at a first rotational speed and to apply a first axial feed force on the FDS. The first setting is configured to cause flow of the substrate to permit the FDS to penetrate the substrate. The method includes detecting, via a sensor, axial position data of the FDS while operating the automatic tool. The method includes calculating, via a controller, volatility of the axial position data of the FDS. The method includes switching, via the controller, the automatic tool from the first setting to a second setting in response to the controller determining a trigger condition has occurred. The trigger condition includes at least one of: a value of the volatility exceeding a predetermined volatility value; and the value of the volatility being within a predetermined range of a maximum volatility value. The second setting is configured to rotate the FDS at a second rotational speed and to apply a second axial feed force to the FDS. The second rotational speed is less than the first rotational speed.

In variations of the method of the above paragraph, which may be implemented individually or in any combination thereof: the trigger condition includes the value of the volatility exceeding the predetermined volatility value, wherein the predetermined volatility value is greater than or equal to 0.5 mm; the trigger condition includes the value of the volatility being within a predetermined range of a maximum volatility value; the controller switches the automatic tool from the first setting to the second setting in response to the maximum volatility value being achieved; the method further includes calculating a predicted maximum volatility value, wherein the controller switches the automatic tool from the first setting to the second setting based on the maximum volatility value predicted; the value is an average of the volatility over a subset of time.

In still another form, the present disclosure provides for a system for installing a flow drill screw (FDS) including a drive unit, at least one sensor, and a controller. The drive unit is configured to rotate the FDS about an axis at a rotational speed while exerting an axial feed force on the FDS to drive the FDS through at least one substrate. The at least one sensor is configured to detect axial position data of the FDS. The controller is in communication with the at least one sensor. The controller is configured to determine volatility of the axial position data of the FDS and to change the rotational speed and the axial feed force in response to a trigger condition being reached. The trigger condition includes at least one of: a value of the volatility exceeding a predetermined volatility value; and the value of the volatility being within a predetermined range of a maximum volatility value.

In variations of the system of the above paragraph, which may be implemented individually or in any combination thereof: the trigger condition includes the value of the volatility exceeding the predetermined volatility value, wherein the predetermined volatility value is greater than or equal to 0.5 mm; the trigger condition includes the value of the volatility being within a predetermined range of a maximum volatility value; the value is an average of the volatility over a subset of time; controller is configured to determine the volatility using at least one of a true range (TR) formula and a standard deviation formula.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view of an example flow drill screw (FDS);

FIG. 2 is series of sequential phases of a FDS of FIG. 1 during an installation process according to the teachings of the present disclosure;

FIG. 3 is a graph illustrating torque and screw position for an installation process of a flow drill screw according to the teachings of the present disclosure;

FIG. 4 is a graph illustrating axial velocity, screw position, and an erroneous screw position measurement for an installation process of a flow drill screw according to the teachings of the present disclosure;

FIG. 5 is a detailed view of a portion of the graph of FIG. 4, illustrating how axial velocity control can correct for erroneous screw position measurements;

FIG. 6 is a graph illustrating a data plots for an installation process of a flow drill screw according to the teachings of the present disclosure, showing screw velocity compared to volatility of screw position data calculated using two different algorithms according to the teachings of the present disclosure;

FIG. 7 is a detailed view of a portion of the graph of FIG. 6; and

FIG. 8 is a flow chart illustrating a method of installing a flow drill screw according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

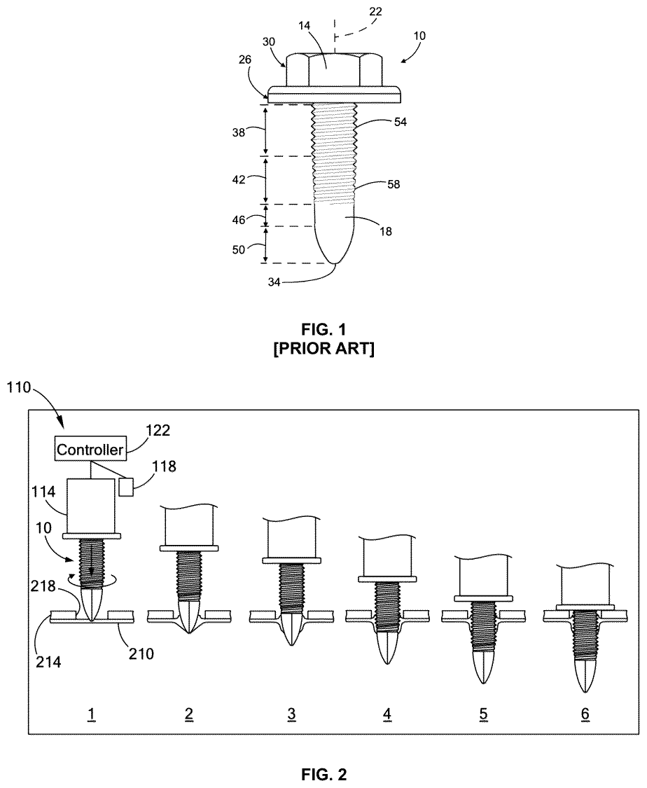

Referring to FIG. 1, a typical FDS 10 is shown and has a head 14 and a shank 18 disposed about a rotational axis 22. The head 14 includes a clamping portion 26 and a tool engagement portion 30. The clamping portion 26 extends radially outward from the shank 18. The tool engagement portion 30 is configured to be gripped by an automatic tool to rotate the FDS 10 about its rotational axis 22. The shank 18 extends in an axial direction from the clamping portion 26 to a tip 34. Between the tip 34 and the clamping portion 26 is a threaded portion 38, a thread forming portion 42, a cylindrical portion 46 and an end portion 50. The tip 34 is typically rounded, relatively smooth, and relatively blunt, as shown, though some typical FDS's may have a more pointed tip. The end portion 50 includes the tip 34 and tapers radially outward to the cylindrical portion 46. The end portion 50 and the cylindrical portion 46 lack threads. In some forms, the cylindrical portion 46 has a constant diameter. In other forms, the cylindrical portion 46 has a diameter that increases more gradually than the end portion 50. The threaded portion 38 has at least one full threadform 54 disposed about the axis 22. The thread forming portion 42 is axially between the cylindrical portion 46 and the threaded portion 38 and has at least one partial threadform 58 that coincides with the at least one full threadform 54 but tapers radially inward from the full threadform 54 toward the cylindrical portion 46. In other words, the thread forming portion 42 has a partial-depth threadform that narrows in diameter (i.e., major diameter) with increased distance from the threaded portion 38. In some forms, not shown, a typical FDS may have a second cylindrical portion between the clamping portion 26 and the threaded portion 38.

Referring to FIGS. 1 and 2, sequential phases or states (labelled 1-6) of the FDS 10 during an installation process by an installation tool 110 are shown. The tool 110 is an automatic tool that includes a driver 114, one or more sensors 118 (only shown in phase 1 for ease of illustration), and a controller 122 (only shown in phase 1 for ease of illustration). The driver 114 is configured to engage the tool engagement portion 30 of the FDS 10 to rotate the FDS 10 about its rotational axis 22 while applying an axial force toward a first substrate 210. The controller 122 is in communication with the driver 114 and the sensors 118 and configured to control operation of the driver 114 and receive input from the sensors 118.

The first substrate 210 can be any suitable material, formed using any suitable process. In one form, the first substrate 210 is aluminum or aluminum alloy. In another form, the first substrate 210 is magnesium or magnesium alloy. In yet another form, the first substrate 210 is steel or a steel alloy. In still another form, the first substrate 210 is a composite material. In some forms, the first substrate 210 can be a stamped sheet of material. In other forms, the first substrate 210 can be a casting. In still other forms, the first substrate 210 can be an extruded piece. In yet other forms, the first substrate may be forged.

While not specifically shown, the driver 114 includes a motor (e.g., electric motor, hydraulic motor, or pneumatic motor) configured to provide rotation and controlled by the controller 122. While not specifically shown, the driver 114 also includes an actuator, which may be actuated by any suitable power source (e.g., electric, hydraulic, or pneumatic power), to apply the axial force. The actuator is controlled by the controller 122. In one form, the actuator is a pneumatic actuator (e.g., pneumatic cylinder) to apply the axial force. In one form, the driver 114 may optionally be disposed a robotic arm (not shown) or pedestal (not shown) and the controller 122 can be configured to control movement of the robotic arm or pedestal.

In the first phase, the FDS 10 is rotated while an axial force is applied on the FDS 10 in the axial direction toward the first substrate 210. In this first or initial phase, the first substrate 210 lacks any thru hole at the location where the FDS 10 is to be installed.

In the example provided, the first substrate 210 is a lower substrate and a second substrate 214 is an upper substrate disposed on top of the first substrate 210 and configured to be clamped to the first substrate 210 by the clamping portion 26 of the FDS 10. In the example provided, the second substrate 214 defines a pre-formed bore 218 that has a diameter greater than the shank 18 but less than the clamping portion 26 so that the clamping portion 26 can clamp the second substrate 214 against the first substrate 210. While only one second substrate 214 is illustrated, additional substrates can be used. For example, in some configurations, not specifically shown the FDS 10 may clamp one, two, three, four, or more additional substrates to the first substrate 210 in addition to the second substrate 214. These additional substrates may optionally have pre-formed thru-holes or the FDS may form the hole therethrough. In the example shown in FIG. 2, the FDS 10 penetrates entirely through the first substrate 210 in the final phase 6.

While the first substrate 210 is shown in FIG. 2 as being thinner than the second substrate 214, in another form, not specifically shown, the first substrate 210 may be thicker than the second substrate 214.

In another alternative configuration, not specifically shown, the first substrate 210 may be the top substrate and a second substrate may be the bottom substrate but without the pre-formed bore 218 (FIG. 2) of the second substrate 214. In this alternative configuration, the FDS 10 can drill through the first substrate 210 and through the second substrate to clamp the first substrate 210 to the second substrate.

In still another alternative configuration, not specifically shown, a second substrate can be entirely omitted and the FDS 10 can be connected only to the first substrate 210. In some such forms, the FDS 10 may include a connection feature (not shown, e.g., a hook, an eyelet, a magnet, surface for receiving adhesive, etc.) so that a mating feature on another component may be coupled to the FDS 10 after the FDS 10 is attached to the first substrate 210.

Returning to FIGS. 1 and 2, at the first phase 1, also referred to as the heating phase, the rotational speed and axial force of the tool 110 are configured to generate friction at the tip 34 to locally heat the substrate an amount sufficient to cause the substrate to melt or soften to a flowable state. In general, the tool 110 continues to rotate the FDS 10 and apply axial pressure thereto until the FDS 10 is fully tightened in the final (e.g., sixth) phase 6, also referred to as the tightening phase.

At phase 2, also referred to as the penetrating phase, the end portion 50 of the FDS 10 begins penetrating into the first substrate 210 but the cylindrical portion 46 has not entered into the first substrate 210. At phase 3, the cylindrical portion begins entering the first substrate 210 but the thread forming portion 42 has not entered into the first substrate 210. Phase 3 is also referred to as the hole forming phase as this is the phase at which the minor diameter of the bore is formed in the first substrate 210. It should be understood that, while phase 3 is shown with the tip 34 fully penetrated through the first substrate 210, the tip 34 may still be within the first substrate 210 depending on the thickness of the first substrate 210. At phase 4, the thread forming portion 42 begins penetrating into the first substrate 210 but the threaded portion 38 has not entered into the first substrate 210. Phase 4 is also referred to as the thread forming phase as the thread forming portion 42 develops the threads at this phase. At phase 5, the threaded portion 38 begins penetrating the first substrate 210. During phase 5, also referred to as the drive down phase, the threaded portion 38 threads into the threads formed by the thread forming portion 42 and progression of the FDS 10 proceeds axially into the first substrate 210 until the clamping portion 26 engages the second substrate 214 (or in the form where the second substrate is below the first substrate 210, the clamping portion 26 engages the first substrate 210) to begin the final phase 6. At phase 6, also referred to as the tightening phase or final tightening phase, the FDS 10 is tightened until fully tight.

In some forms, the sensors 118 can detect a predetermined end trigger condition and the controller 122 controls the driver 114 to tighten the FDS 10 until the predetermined end trigger condition. In one form, the sensors 118 can include a torque sensor and the end trigger condition may be a predetermined final torque value. The predetermined final torque value is less than a torsional strength rating of the FDS 10. In another form, sensors 118 can include a depth or position sensor to detect position data and the predetermined end trigger condition can be a depth or position of the FDS 10 and/or a pre-determined torque value.

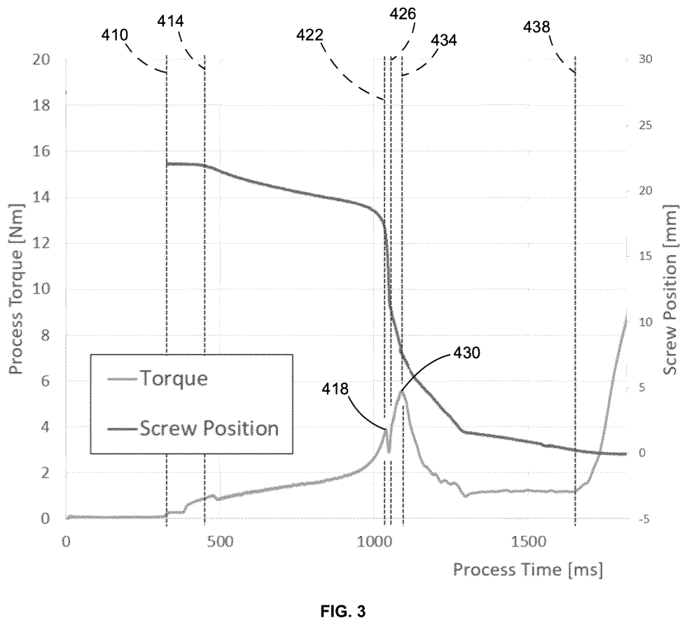

Referring to FIG. 3, torque and screw axial position (i.e., depth) are illustrated over time during an installation process of a FDS 10. In this graph, the maximum screw position (i.e., at line 410) refers to the position at which the tip 34 of the FDS 10 initially contacts the first substrate 210 and the screw position of 0 mm (zero mm) refers to the final position wherein the clamping portion 26 clamps the second substrate 214 against the first substrate 210 (or in the form where the second substrate is below the first substrate 210, the clamping portion 26 engages the first substrate 210).

Referring to FIGS. 2 and 3, phase 1 (i.e., the heating phase) begins at line 410 and proceeds to line 414. During this phase, the torque rises but the axial position of the FDS 10 remains stationary as heat builds up.

Phase 2 (i.e., the penetrating phase) begins at line 414. During this phase, the torque continues to rise to a first peak 418 and the axial position of the FDS 10 progresses slowly downward (i.e., toward zero mm) as the tip 34 begins penetrating the first substrate 210. As shown, the axial position of the FDS 10 may begin to slowly move downward while the tip 34 continues to penetrate the first substrate 210 due to the first substrate 210 continuing to soften due to the buildup of heat.

Phase 3 (i.e., the hole forming phase) begins at line 422. During this phase, the torque drops and the axial position of the FDS 10 moves quickly downward as the cylindrical portion 46 enters the first substrate 210.

Phase 4 (i.e., the thread forming phase) begins at line 426. During this phase, the torque rises quickly to a second peak 430 and the axial position of the FDS 10 continues downward, though at a slower rate than during phase 3, as the thread forming portion 42 enters the first substrate 210 and forms threads in the first substrate 210.

Phase 5 (i.e., the drive down phase) begins at line 434. During this phase, the torque decreases to a generally steady state as the axial position of the FDS 10 continues downward via mating action of the threaded portion 38 and the threads formed in the first substrate 210 by the thread forming portion 42 during phase 4.

Phase 6 (i.e., the final tightening phase) begins at line 438. During this phase, the torque rises steeply while the axial position of the FDS 10 remains substantially at zero mm. The torque rises until the end trigger condition is met and the controller 122 stops rotation of the driver 114.

At the start of phase 1 (line 410), the tool 110 is controlled to operate at a first setting in which the tool 110 is controlled to operate at a first rotational speed and first axial feed force. At some point between the start of phase 3 (line 422) and the start of phase 6 (line 438), the tool 110 is controlled to switch from the first setting to a second setting, in which the tool 110 is controlled to operate at a second RPM and a second axial feed force (which may optionally be the same as or different than the first axial feed force). The first rotational speed is also referred to herein as a high rotational speed and can be in the range of 1,500 to 11,000 RPM, inclusive. In one form, the first rotational speed is more specifically in the range of 2,000 to 8,000 RPM, inclusive. In another form, the first rotational speed is more specifically in the range of 6,000 to 11,000 RPM, inclusive. The first axial feed force is also referred to herein as a high axial feed force and is in the range of between 0.5 to 2.5 kilonewtons (kN), inclusive. In one form, the first axial feed force may be in the range of between 1 to 2 kN. The second rotational speed is also referred to herein as a low rotational speed and is in the range of 500 to 4,000 RPM, inclusive. In one form, the second rotational speed can be within this range but is less than the first rotational speed, though other configurations can be used. The second axial feed force is also referred to herein as a low axial feed force and is in the range of 0.25 to 1.25 KN, inclusive. In one form, the second axial feed force can be within this range but is less than the first axial feed force, though other configurations can be used. For example, in another form, the second axial feed force may be equal to or greater than the first axial feed force.

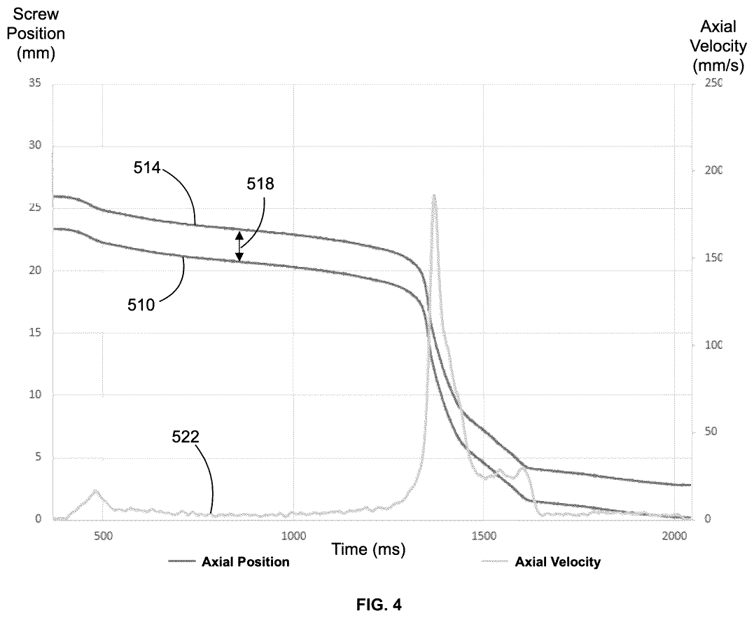

Referring to FIG. 4, two sets of data for screw axial position (i.e., depth) of the same screw is illustrated over time during an installation process of the FDS 10. A first position curve 510 is formed by a first set of screw position data measured by the sensors 118. A second position curve 514 is formed by a second set of screw position data measured by the sensors 118. The difference 518 in measured screw position data can be due to any number of factors (e.g., errors in the calibration between two position sensors 118).

FIG. 4 also illustrates the axial velocity 522 of the FDS 10 over time during the installation process. As shown in FIG. 4, the axial velocity 522 is the same for both position curves 510, 514. It has been found that the axial velocity is effectively the same or has very little difference even if the two position curves are produced using the same sensor 118 but for the same general process with a subsequent screw (e.g., where the difference 518 in measured position data is due to other factors such as dimensional tolerances in the FDS 10, tolerances in the first substrate 210, and/or tolerances in the second substrate 214).

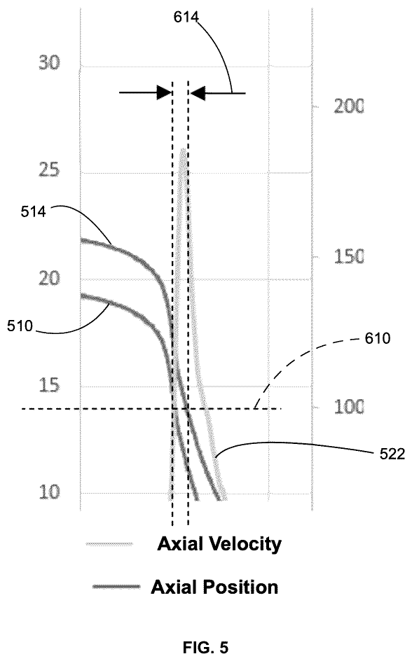

Referring to FIG. 5, when a specific axial position (e.g., depth) value is used as the trigger point (e.g., threshold 610) to switch from the first setting (e.g., high rotational speed and high axial feed force) to the second setting (e.g., low rotational speed and low axial feed force), an error (shown by distance 614 between the time when the first position data 510 crosses that value 610 and when the second position data 514 crosses that value 610 can be created. However, if the threshold 610 is a specific axial velocity value, instead of an axial position value, then it has been found to eliminate (as in the example shown) or greatly reduce this error, while ensuring the process can function as intended.

However, it has been found that, due to many factors (e.g., signal propagation times, signal processing times, sampling speed, rotational momentum in the system), these typical trigger conditions (e.g., position threshold or axial velocity threshold) can end up being a lagging indicator of the true position of the FDS 10, particularly when using smoothed axial velocity data. In other words, by the time the actual rotation and axial force of the FDS 10 is reduced (compared to the time when the controller sends the signal(s) to reduce the rotation and axial force), the FDS 10 may already be beyond the most desirable axial position relative to the substrate(s). Furthermore, if raw axial velocity data is used, that data can be very noisy, i.e., producing a not smooth curve of data. This can also increase variability in the true position of the FDS with regard to when the axial velocity threshold is triggered by the raw axial velocity data.

Nevertheless, axial velocity can still be a lagging indicator of actual FDS 10 characteristics, as discussed in more detail in co-owned U.S. patent application Ser. No. 18/466,775, titled “Method and System with Acceleration Based Flow Drill Screw Control, filed Sep. 13, 2023, the entirety of which is incorporated herein by reference.

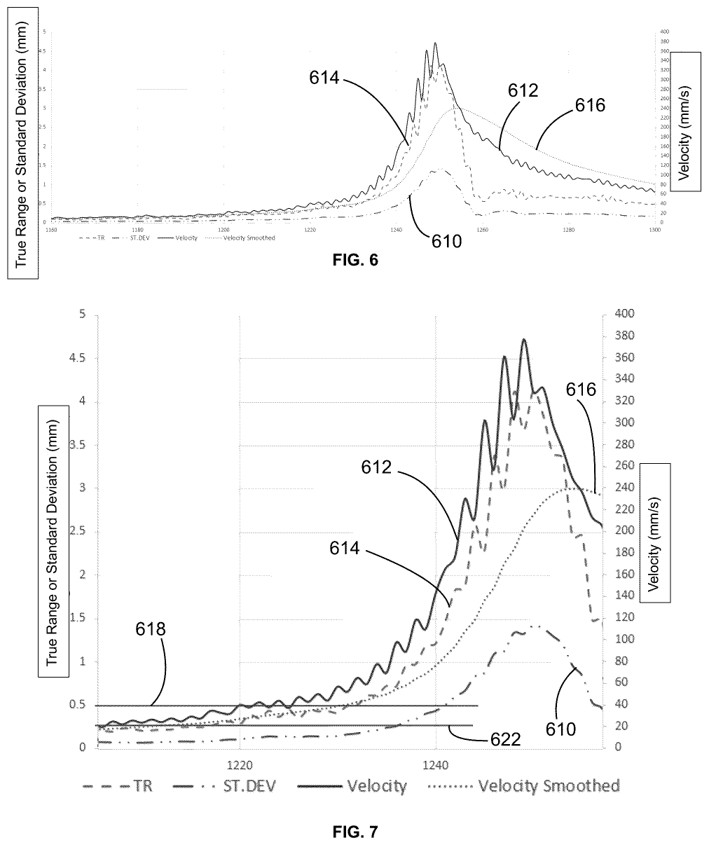

Referring to FIGS. 6 and 7, the controller 122 (FIG. 2) is configured to calculate, in real-time, a volatility of the axial position data (e.g., first position data 510 or second position data 514 of FIGS. 3-5) detected by the sensor 118 (FIG. 2). The volatility can be calculated using any suitable algorithm for calculating volatility of a data set. Thus, the controller can output a volatility data set. In one form, the controller 122 can calculate the volatility of the axial position data by using a Standard Deviation algorithm (ST.DEV function or formula) on the axial position data, as indicated by plot 610. In another form, the controller 122 can calculate the volatility of the axial position data by using a True Range algorithm (TR function or formula) on the axial position data, as indicated by plot 614. While standard deviation and true range are shown, other volatility algorithms can be used.

The volatility algorithm can use any suitable lookback time period. In one form, the volatility algorithm can use a lookback period of 10 ms, though other time periods can be used.

Surprisingly, as can be best seen in FIG. 7, the calculated volatility data set (e.g., plot 610 or 614) provides an identifiable change in signal that has been found to repeatably correlate to the process conditions (e.g., phase of installation) during installation of the FDS 10 (FIGS. 1 and 2). The volatility algorithms also can also provide a smoother data curve, when compared to the raw velocity data (plot 612), which can lead to more consistent results and the ability to more accurately detect a change in the data curve (e.g., from initial steady state conditions) earlier than other forms of data. As can be seen with at least the True Range algorithm plot 614, some of these volatility algorithms can also provide an identifiable change in signal earlier than other sources of data such as the smoothed velocity data (plot 616). Thus, the controller 122 (FIG. 2) can be configured to check, in real-time, when the volatility data reaches a predetermined threshold volatility value.

In the example provided, this predetermined volatility threshold value for the True Range algorithm data (i.e., plot 614) can be greater than or equal to 0.5 mm (e.g., threshold 618), though other threshold values can be used, including lower or higher values depending on where a repeatable and identifiable change in signal exists for a particular FDS application. In the example provided, the predetermined volatility threshold value for the Standard Deviation algorithm can be greater than or equal to 0.25 mm (e.g., threshold 622), though other threshold values can be used, including lower or higher values depending on where a repeatable and identifiable change in signal exists for a particular FDS application.

This threshold volatility value can provide a more precise and repeatable trigger while also providing a leading indicator. In other words, screw position volatility data can provide a curve that can repeatably produce an identifiable threshold trigger that occurs early enough in the installation process that the controller 122 can act on this threshold so that the delays in data processing, signal propagation, and physical momentum of components can be compensated for. In other words, setting the trigger to be the volatility threshold value results in a much earlier trigger for the controller 122 to send control signals such that the FDS 10 actually physically achieves the second rotational speed and the second axial feed force sooner than would normally be possible with axial position or some other data value thresholds.

The value of the threshold value (also referred to as trigger value) at line 618 or 622 is shown in FIG. 7 for explanation purposes and may be chosen at other volatility values than that shown. The actual volatility threshold value may also be different due to the data collection processes implemented, the type of volatility algorithm used, and, if applicable, the smoothing processes implemented. For example, different data collection and/or volatility algorithm and/or the smoothing processes can change the values of the data set being used and the threshold value can be chosen accordingly. Likewise, the values of the data plots or curves shown in the graphs of the figures are also shown for explanation purposes and may be different depending on the data collection and/or smoothing processes used.

In one form, the controller 122 can calculate the volatility directly from the raw axial position data. In another form, the controller 122 can apply a smoothing filter to the raw axial position data and then calculate the volatility using the smoothed axial position data. In another form, the controller 122 can apply a smoothing filter to the calculated volatility data without first smoothing the raw axial position data before calculating the volatility. In still another form, the controller 122 can apply a smoothing filter to the calculated volatility data after first smoothing the raw axial position data before calculating the volatility.

In one form, the controller 122 analyzes each volatility data value individually to determine if it is at or exceeding the volatility threshold. In another form, the controller 122 calculates an average of the volatility values over a subset of time and analyzes that average value to determine if it is at or exceeding the volatility threshold.

In one form, the volatility threshold value 618 can be greater than or equal to 0.25 mm, though other threshold values can be used (e.g., 0.5 mm, or 1 mm, or anywhere in the range of 0.25 mm to 4 mm) depending on the data collection and/or volatility algorithm and/or smoothing processes used.

In one configuration of this form, the controller 122 sends control signals to switch to the second setting immediately upon determining that the volatility data (e.g., 610 or 614) has reached or exceeded the volatility threshold value 618. In another configuration of this form, the controller 122 starts a predetermined time delay immediately upon determining that the volatility data (e.g., 610 or 614) has reached or exceeded the volatility threshold value 618 and then sends control signals to switch to the second setting immediately upon the end of the time delay. In some forms, this time delay may be between 1 and 30 ms, inclusive.

In still another configuration of this form, the controller 122 does not use a predetermined time delay and, instead, uses a predetermined axial positional delay. In other words, the controller 122 starts analyzing the measured axial position data immediately upon determining that the volatility data (e.g., 610 or 614) has reached or exceeded the volatility threshold value 618 and then sends control signals to switch to the second setting immediately upon the axial position data showing that the FDS 10 has moved a predetermined axial distance after the volatility threshold value 618. In some forms, this predetermined axial distance may be between 0.5 and 10 mm, inclusive. In some forms, this predetermined axial distance may be between 0.5 and 2 mm, inclusive. In some forms, this predetermined axial distance may be between 0.5 and 1 mm, inclusive.

In another form, not specifically shown, the volatility threshold value 618 may be set to be the maximum volatility achieved (e.g., at point 626 or 630 of FIG. 7) or can be set based on a determination of the maximum volatility to be achieved. In other words, the controller 122 may be configured to switch to the second setting upon determining that the maximum volatility (e.g., point 626 or 630) has been achieved. In one configuration of this form, the controller 122 may switch immediately upon determining that the maximum volatility has been achieved. In another configuration, the controller 122 may be configured to switch immediately after a predetermined time delay after the maximum volatility is achieved. In another configuration, the controller 122 may be configured to switch immediately after a predetermined axial positional delay after the maximum volatility is achieved.

The controller 122 can determine the maximum volatility in any suitable manner, including but not limited to any of the following examples individually or in any suitable combination thereof. In one example, the controller 122 compares each volatility value to subsequent volatility values and determines that the maximum value is the value that has at least two subsequent volatility values below it. In another example, the controller 122 takes the derivative of the volatility data values in real-time and determines that the maximum volatility is the value at which the derivative (i.e., slope) of the volatility curve (e.g., 610 or 614) starts going negative.

In another example, the controller 122 may fit a mathematical model (e.g., moving average) to the volatility data and predict when the volatility will reach the maximum. In the example where the controller 122 predicts the maximum volatility, the controller 122 may switch to the second setting a predetermined time or position before that maximum so that the delays in signal processing, momentum, etc. are compensated for. In other words, the volatility threshold 618 may be within a predetermined range of the maximum volatility value.

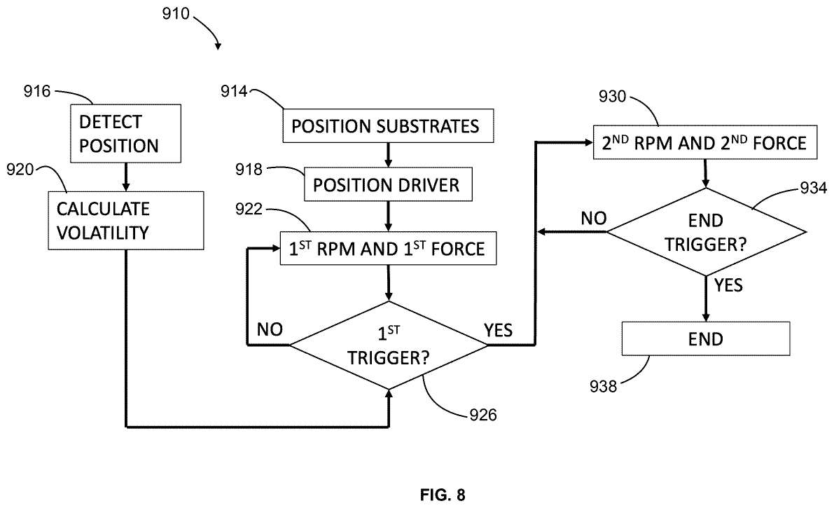

Referring to FIGS. 2 and 8 an installation process or method 910 is illustrated. The installation method 910 includes step 914. At step 914, the substrate or substrates (e.g., the first substrate 210 and the second substrate 214) are positioned. The method 910 then proceeds to step 918.

At step 918, the controller 122 positions the driver 114 to be engaged with the FDS 10 and so that the tip 34 of the FDS 10 contacts the first substrate 210 at a predetermined location on the first substrate 210. The method 910 then proceeds to step 922.

The beginning of step 922 corresponds to line 410 (FIG. 4). At step 922, the controller 122 operates the automatic tool 110 at a first setting. For the first setting, the controller 122 controls the driver 114 to rotate at the first rotational speed and to apply the first axial force on the FDS 10. In other words, the controller 122 sends signals to the driver 114 to cause the driver 114 to rotate the FDS 10 at the first rotational speed while pressing the FDS 10 against the first substrate 210 with a first axial feed force.

While minor fluctuations may occur, the control signals from the controller 122 for the first setting are configured to operate the driver at a constant rotational speed and axial feed force during step 922.

As shown by step 916, while the driver 114 is applying the first rotational speed and the first axial feed force, the sensor(s) 118 detect a depth or position of the FDS 10. The controller 122 receives signals from the sensor(s) 118.

At step 920, the controller 122 calculates the volatility data (e.g., volatility data 610 or 614) as discussed above. As discussed above, the controller 122 may optionally applying a smoothing filter to the directly detected position data and/or the volatility data.

Returning to the example provided, at step 926, the controller 122 determines, based on the volatility data from step 920, if a predetermined first trigger condition is met. The first trigger condition of the method 910 is a threshold volatility value, such as threshold volatility value 618 (FIG. 7) and/or those otherwise discussed above.

The controller 122 continues operating the driver 114 at the first rotational speed and the first axial feed force until the first trigger condition is met. The detection of the first trigger condition is configured to be such that the FDS 10 will achieve the start of phase 3 at line 422 (FIG. 3) and compensate for the delays in data processing, signal propagation, physical momentum of components as discussed above. When the first trigger condition is met, the method 910 proceeds immediately and directly to step 930. In an alternative form, as discussed above, the controller 122 can implement a time or position delay after the first trigger condition is met and then immediately and directly proceed to step 930.

At step 930, the controller 122 operates the automatic tool 110 at a second setting. At the second setting, the controller 122 sends a signal to the driver 114 to immediately begin operating the driver 114 at a second rotational speed and a second axial feed force.

While minor fluctuations may occur, the control signals from the controller 122 for the second setting are configured to operate the driver at a constant rotational speed and axial feed force during step 930.

While the driver 114 is applying the second rotational speed and the second axial feed force, the sensor(s) 118 may continue to detect the depth (i.e., position) of the FDS 10. The sensor(s) 118 may also detect torque values. The controller 122 continues to receive signals from the sensor(s) 118.

At step 934, the controller 122 determines, based on signals from the sensor(s) 118 if a predetermined end trigger condition is met. The end trigger condition may be a final torque value. The controller 122 continues operating the driver 114 at the second rotational speed and the second axial force until the end trigger condition is met. Once the end trigger condition is met, the controller 122 stops the rotation and axial force of the driver 114 to end the method, as indicated by step 938. It is understood that additional steps may be taken upon reaching step 938 and to say that the specific method discussed ends is not to require that the driver 114 and/or controller 122 must stop operating in all capacity at this point. For example, industry standard processes for torque control to tighten up the joint may be used.

In another form, the device and methods described herein can also be combined with the teachings of U.S. application Ser. No. 18/365,660, filed Aug. 4, 2023, the entire disclosure of which is incorporated herein by reference. For example, the screw volatility threshold of the present disclosure may be used as the first trigger condition described in U.S. application Ser. No. 18/365,660 instead of the axial velocity (i.e., depth gradient) described therein.

Thus, this method and system described herein compensate for variations in sensors, screw geometry, substrate geometry, and other manufacturing factors such as gaps from part fit-up in the assemblies and fixtures.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of installing a flow drill screw (FDS) into a substrate, the method comprising:
engaging the FDS with an automatic tool;
operating the automatic tool at a first setting to drive the FDS into the substrate by causing flow of the substrate to permit the FDS to penetrate the substrate, the first setting being configured to rotate the FDS at a first rotational speed and to apply a first axial feed force on the FDS, the first setting being configured to cause flow of the substrate to permit the FDS to penetrate the substrate;
detecting, via a sensor, axial position data of the FDS while operating the automatic tool;
calculating, via a controller, volatility of the axial position data of the FDS; and
switching the automatic tool from the first setting to a second setting in response to the volatility, wherein the second setting is configured to rotate the FDS at a second rotational speed and to apply a second axial feed force to the FDS, wherein the second rotational speed is less than the first rotational speed.

2. The method according to claim 1, wherein the controller switches the automatic tool from the first setting to the second setting in response to the controller determining a trigger condition has occurred, the trigger condition including at least one of:
a value of the volatility exceeding a predetermined volatility value; and
the value of the volatility being within a predetermined range of a maximum volatility value.

3. The method according to claim 2, wherein the predetermined volatility value is greater than or equal to 0.5 mm.

4. The method according to claim 2, wherein the controller is configured to wait a predetermined delay time after the controller determines that the trigger condition has occurred and before switching the automatic tool from the first setting to the second setting.

5. The method according to claim 2, wherein the value is an average of the volatility over a subset of time.

6. The method according to claim 1, wherein the controller switches the automatic tool from the first setting to the second setting in response to a maximum volatility value being achieved.

7. The method according to claim 1, further comprising calculating a predicted maximum volatility value, wherein the controller switches the automatic tool from the first setting to the second setting based on the maximum volatility value predicted.

8. The method according to claim 7, wherein the controller switches the automatic tool from the first setting to the second setting based on the maximum volatility value predicted but before the maximum volatility value is achieved.

9. The method according to claim 1, wherein controller calculates the volatility using at least one of a true range (TR) formula and a standard deviation formula.

10. A method of installing a flow drill screw (FDS) into a substrate, the method comprising:
engaging the FDS with an automatic tool;
operating the automatic tool at a first setting to drive the FDS into the substrate by causing flow of the substrate to permit the FDS to penetrate the substrate, the first setting being configured to rotate the FDS at a first rotational speed and to apply a first axial feed force on the FDS, the first setting being configured to cause flow of the substrate to permit the FDS to penetrate the substrate;
detecting, via a sensor, axial position data of the FDS while operating the automatic tool;
calculating, via a controller, volatility of the axial position data of the FDS; and
switching, via the controller, the automatic tool from the first setting to a second setting in response to the controller determining a trigger condition has occurred, the trigger condition including at least one of:
a value of the volatility exceeding a predetermined volatility value; and
the value of the volatility being within a predetermined range of a maximum volatility value;
wherein the second setting is configured to rotate the FDS at a second rotational speed and to apply a second axial feed force to the FDS, wherein the second rotational speed is less than the first rotational speed.

11. The method according to claim 10, wherein the trigger condition includes the value of the volatility exceeding the predetermined volatility value, wherein the predetermined volatility value is greater than or equal to 0.5 mm.

12. The method according to claim 10, wherein the trigger condition includes the value of the volatility being within a predetermined range of a maximum volatility value.

13. The method according to claim 12, wherein the controller switches the automatic tool from the first setting to the second setting in response to the maximum volatility value being achieved.

14. The method according to claim 12, further comprising calculating a predicted maximum volatility value, wherein the controller switches the automatic tool from the first setting to the second setting based on the maximum volatility value predicted.

15. The method according to claim 10, wherein the value is an average of the volatility over a subset of time.

16. A system for installing a flow drill screw (FDS) comprising:
a drive unit configured to rotate the FDS about an axis at a rotational speed while exerting an axial feed force on the FDS to drive the FDS through at least one substrate;
at least one sensor configured to detect axial position data of the FDS; and
a controller in communication with the at least one sensor, the controller being configured determine volatility of the axial position data of the FDS and to change the rotational speed and the axial feed force in response to a trigger condition being reached, the trigger condition including at least one of:
a value of the volatility exceeding a predetermined volatility value; and
the value of the volatility being within a predetermined range of a maximum volatility value.

17. The system according to claim 16, wherein the trigger condition includes the value of the volatility exceeding the predetermined volatility value, wherein the predetermined volatility value is greater than or equal to 0.5 mm.

18. The system according to claim 16, wherein the trigger condition includes the value of the volatility being within a predetermined range of a maximum volatility value.

19. The system according to claim 16, wherein the value is an average of the volatility over a subset of time.

20. The system according to claim 16, wherein controller is configured to determine the volatility using at least one of a true range (TR) formula and a standard deviation formula.
